(19) United States
(12) Patent Application Publication
(10) Pub. No.: US 2025/0306367 A1
(43) Pub. Date: Oct. 2, 2025

(54) Holographic Waveguide Display with Light Control Layer

(71) Applicant: DigiLens Inc., Sunnyvale, CA (US)

(72) Inventors: Jonathan David Waldern, Diablo, CA (US); Alastair John Grant, San Jose, CA (US); Milan Momcilo Popovich, Leicester (GB)

(73) Assignee: DigiLens Inc., Sunnyvale, CA (US)

(21) Appl. No.: 19/038,622

(22) Filed: Jan. 27, 2025

Related U.S. Application Data
(63) Continuation of application No. 18/311,851, filed on May 3, 2023, now Pat. No. 12,210,153.
Application No. 18/311,851 is a continuation of application No. 16/705,030, filed on Dec. 5, 2019, now abandoned.
(60) Provisional application No. 62/792,309, filed on Jan. 14, 2019.

(51) Int. Cl. G02B 27/01; G02B 5/32

(52) U.S. Cl. CPC G02B 27/0103; G02B 5/32; G02B 2027/0112; G02B 2027/0118

(57) ABSTRACT

Waveguides and waveguide displays having a layer for blocking non-image light (i.e. haze) that could otherwise reduce contrast and degrade color gamut and uniformity, while providing high transmission to external light are provided. Many waveguides and displays incorporate at least one light control layer applied to at least one external surface of said waveguide and overlapping at least a portion of said at least one grating, to divert or block scattered light from said set of gratings that might otherwise enter said eyebox.

### CROSS-REFERENCE TO RELATED APPLICATIONS

The present application is a continuation of U.S. patent application Ser. No. 18/311,851, filed May 3, 2023, which claims priority to U.S. patent application Ser. No. 16/705,030, filed Dec. 5, 2019, which claims priority to U.S. Provisional Application No. 62/792,309, filed Jan. 14, 2019, the disclosures of which are incorporated herein by reference in their entirety.

### FIELD OF THE INVENTION

The present disclosure generally relates to waveguide devices and, more specifically, to a holographic waveguide display using a light control layer to limit haze.

### BACKGROUND OF THE INVENTION

Scatter from particulates suspended in holographic gratings, and HPDLC gratings in particular, can result in haze, which reduces image contrast, color fidelity, and brightness uniformity. The main contributor to haze can stem from the fold grating where the large number of beam grating interactions for beam folding and expansion can lead to millions of scattering events. Much of this scatter can find its way into the eye box of the display. In contrast, input and output gratings typically have a very small number of beam grating interactions.

The use of light control films in waveguides are described in U.S. patent application Ser. No. 13/317,468 entitled “Holographic Waveguide Display” which discloses “light control film applied to either substrate to block stray light that would otherwise reduce contrast and degrade color gamut” and U.S. patent application Ser. No. 13/844,456 entitled “Transparent Waveguide Display” which discloses the use of “holographic brightness enhancing film, or other narrow band reflector” that is “affixed to one side of the display, the purpose of which is to reflect the display illumination wavelength light only. Both disclosures are incorporated by reference herein in their entireties.

### SUMMARY OF THE INVENTION

The present disclosure provides a waveguide with a layer for blocking non-image light (i.e. haze) that could otherwise reduce contrast and degrade color gamut and uniformity, while providing high transmission to external light.

Many embodiments are directed to a waveguide display including:
a waveguide supporting at least one grating;
a source of data modulated light;
a set of gratings configured to:
   direct said data modulated light into a total internal reflection path in said waveguide; and
   provide beam expansion and extraction of data modulated light from said waveguide into an eyebox; and
at least one light control layer applied to at least one external surface of said waveguide and overlapping at least a portion of said at least one grating, wherein said light control layer is operative to divert or block scattered light from said set of gratings that might otherwise enter said eyebox.

In many such embodiments, said set of gratings comprises at least one fold grating and at least one output grating, said fold grating directing said modulated light to said output grating and providing a first beam expansion, said output grating directing said modulated light out of said waveguide towards said eye box with beam expansion orthogonal to said first beam expansion.

In still many such embodiments, said set of gratings comprises an input coupler comprising at least one of a prism or a grating.

In yet many such embodiments, said light control layer has at least one region having reflection characteristics dependent on at least one property of light incident on said region selected from the group of spectral bandwidth, incidence angle range, and polarization state.

In still yet many such embodiments, said light control layer region overlaps a fold grating.

In still many such embodiments, said light control layer region overlaps an output grating.

In still many such embodiments, said light control layer has a reflection characteristic that varies spatially across said at least one region.

In still many such embodiments, said at least one light control layer comprises at least one layer comprising at least one selected from the group of a narrow band interference filter, a dichroic filter, a reflection hologram, a micro louvre film, a birefringent film, a reflective polarizer, a polarization selective film, a film containing microparticles, a transparent substrate and an air space.

In still many such embodiments, said data modulated light is provided by one of a broadband light source, a laser emitter, a LED emitter or a module comprising one or more selected from the group of red, green and blue laser or LED emitters.

In still many such embodiments, said source of data modulated light comprises: a microdisplay for displaying image pixels and collimation optics and a lens for projecting the image displayed on said microdisplay panel such that each image pixel on said microdisplay is converted into a unique angular direction within said waveguide.

In still many such embodiments, said source of data modulated light is a laser projector comprising a beam scanning mechanism and a light modulator.

In still many such embodiments, at least one of said set of gratings is characterized by at least one of spatially varying pitch, rolled k-vectors, multiplexed gratings, and dual interaction gratings.

In still many such embodiments, at least one of said set of gratings is selected from the group of a switchable Bragg grating recorded in a holographic photopolymer a HPDLC material or a uniform modulation holographic liquid crystal polymer material and a surface relief grating.

In still many such embodiments, said set of gratings comprises:
an input coupler;
an output coupler comprising multiplexed first and second gratings;
a first fold grating for directing light in a first spectral band along a first path from said input coupler to said output coupler and providing a first beam expansion; and
   a second fold grating for directing light in a second spectral band along a second path from said input coupler to said output coupler and providing a first beam expansion, wherein:
      said first multiplexed grating configured to direct said first spectral band out of said waveguide in a first direction with beam expansion orthogonal to said first beam expansion;
      said second multiplexed grating configured to direct said second spectral band out of said waveguide in said first direction with beam expansion orthogonal to said first beam expansion;
      said at least one light control layer comprises a first region having high reflectivity in at least one portion of said first spectral band and overlapping said first fold grating; and
      said at least one light control layer further comprising a second region having high reflectivity in at least one portion of said second spectral band and overlapping said second fold grating.

In still many such embodiments, said first spectral band extends from blue to green and said first region has high reflectivity for blue and green light with spectral bandwidths substantially narrower than said first spectral band, wherein said second spectral band extends from green to red and said second region has high reflectivity for green and red light with spectral bandwidths substantially narrower than said second spectral band.

In still many such embodiments, said input coupler comprises at least one of a prism and a grating.

In still many such embodiments, said first and second fold grating and said multiplexed grating are formed in a single layer.

In still many such embodiments, said input coupler is a grating formed in said single layer.

In still many such embodiments, said at least one light control layer is formed by a stack of layers each containing a region providing reflection in spectral bandwidth substantially narrower than said first spectral band or said second band.

In still many such embodiments, said source of data modulated light is a laser projector and said light is provided by red, green, and blue laser emitters.

Additional embodiments and features are set forth in part in the description that follows, and in part will become apparent to those skilled in the art upon examination of the specification or may be learned by the practice of the disclosed subject matter. A further understanding of the nature and advantages of the present disclosure may be realized by reference to the remaining portions of the specification and the drawings, which forms a part of this disclosure.

### BRIEF DESCRIPTION OF THE DRAWINGS

These and other features and advantages of the present apparatus and methods will be better understood by reference to the following detailed description when considered in conjunction with the accompanying data and figures, which are presented as exemplary embodiments of the disclosure and should not be construed as a complete recitation of the scope of the inventive method, wherein:

FIG. 1 conceptually illustrates a schematic cross section view of a waveguide display comprising a waveguide substrate, a grating layer, and a light control layer disposed on the waveguide surface facing the eye box in accordance with embodiments.

FIG. 2 conceptually illustrates a schematic cross section view of a waveguide display comprising a waveguide substrate, a grating layer, and a light control layer disposed on the outside surface of the waveguide in accordance with embodiments.

FIG. 3 conceptually illustrates a schematic cross section view of a waveguide display comprising a waveguide substrate, a grating layer, and a light control layer disposed on the waveguide surface facing the eye box and separated from the waveguide by an air gap in accordance with embodiments.

FIG. 4 conceptually illustrates a schematic cross section view of a waveguide display comprising a waveguide substrate, a grating layer, and light control layers disposed on both outer surfaces of the waveguide in accordance with embodiments.

FIG. 5 conceptually illustrates a schematic cross section view of the waveguide display similar to the embodiment of FIG. 1 in which the light control layer contains a reflecting region overlapping a fold grating in accordance with embodiments.

FIG. 6 conceptually illustrates a schematic cross section view of the waveguide display similar to the embodiment of FIG. 1 in which the light control layer contains reflecting regions overlapping a fold grating and an output grating in accordance with embodiments.

FIG. 7 conceptually illustrates a schematic cross section view of a waveguide display providing bifurcated waveguide paths for two spectral bands using upper and lower fold gratings and a multiplexed output grating and further comprising a light control layer with reflecting regions overlapping the upper and lower fold gratings in accordance with embodiments.

FIG. 8 conceptually illustrates a schematic cross section view of a light control layer comprising two stacked narrow band reflecting interference filters in accordance with embodiments.

FIG. 9 is a chart showing the spectral transmission characteristics of a first light control layer region based on the embodiment of FIG. 8 for use in the embodiment of FIG. 7 in accordance with embodiments.

FIG. 10 is a chart showing the spectral transmission characteristics of a second light control layer region based on the embodiment of FIG. 8 configured for use in the embodiment of FIG. 7 in accordance with embodiments.

FIG. 11 is a chart illustration the spatial variation of a light control layer characteristic in accordance with embodiments.

### DETAILED DESCRIPTION OF THE INVENTION

For the purposes of describing embodiments, some well-known features of optical technology known to those skilled in the art of optical design and visual displays have been omitted or simplified in order to not obscure the basic principles of the disclosure. Unless otherwise stated the term “on-axis” in relation to a ray or a beam direction refers to propagation parallel to an axis normal to the surfaces of the optical components described in relation to the embodiment. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating comprised of a set of gratings in some embodiments. For illustrative purposes, it is to be understood that the drawings are not drawn to scale unless stated otherwise.

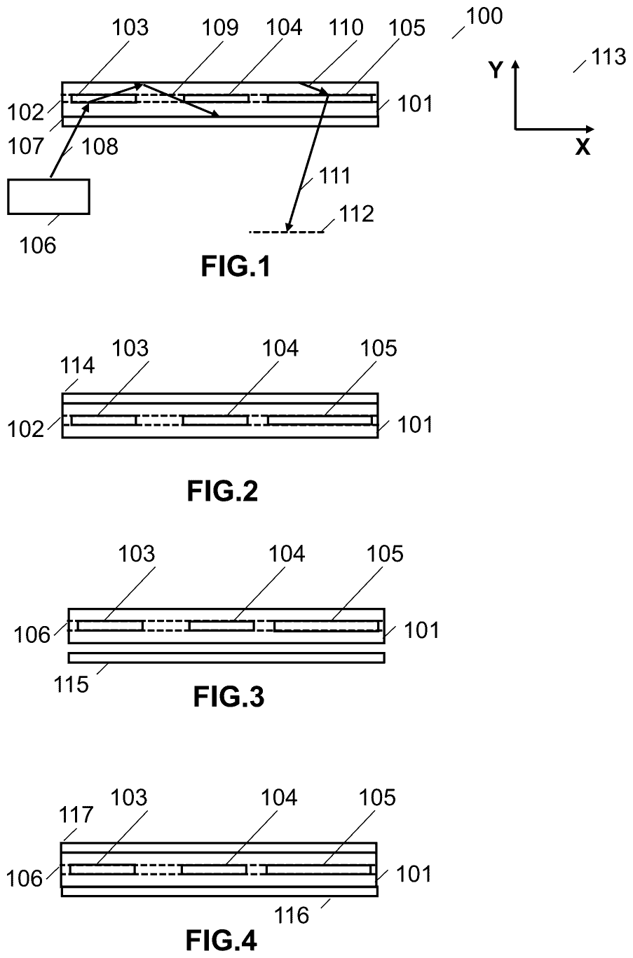

FIG. 1 conceptually illustrates a schematic plan view of a waveguide display in accordance with embodiments. In the illustrative embodiment, the waveguide display 100 includes a waveguide 101 supporting a grating layer containing an input coupler grating 103, a fold grating 104, and an output grating 105. The fold grating 104 can be configured to direct light to the output grating 105 and to provide a first beam expansion. The output grating 105 can be configured to direct light out of the waveguide 101 towards an eye box 112 with beam expansion orthogonal to the first beam expansion. Note that for simplicity the gratings are shown as separated in the cross section whereas in a practical display waveguide, at least two of the gratings could overlap in any cross-sectional view. The apparatus further comprises a source of data modulated light 106 and a light control layer 107 applied to an external surface of the waveguide overlapping the grating layer. For the purposes of explaining embodiments, the light control layer will be considered to be a coating or film applied to the outer surface of one or both of the waveguide substrates sandwiching the grating layer. However, in many embodiments, the light control layer may actually comprise more than one layer. The beam paths from input to extraction from the waveguide are illustrated by ray paths 108-111, which provide an image for viewing from the eyebox 112. The light control layer 107 is operative to divert or block scattered light from the grating that might otherwise enter the eyebox. FIG. 1 also shows the cartesian reference frame (113) of the waveguide.

Any of the gratings used in embodiments can be configured as multiplexed gratings, rolled k-vector gratings, and/or dual interaction gratings. In some embodiments, gratings with spatially varying pitch can be used. The gratings can be implemented in multiple layers or in a single layer. In many embodiments, the gratings are Bragg gratings recorded in a holographic photopolymer, in a HPDLC material, or in a uniform modulation holographic liquid crystal polymer material. In some embodiments, one or more of the gratings may be configured to be electrically switchable. In some embodiments, surface relief gratings may be used.

Present embodiments may also use any of the embodiments disclosed in U.S. application Ser. No. 16/242,979 entitled “Waveguide Architectures and Related Methods of Manufacturing,” disclosure of which is incorporated by reference herein in its entirety.

Image data can be coupled into the waveguide by means of an input coupler which can comprise at least one of a prism or a grating, as shown in FIG. 1. In many embodiments, the source of data modulated light comprises a microdisplay for displaying image pixels and collimation optics and a lens for projecting the image displayed on the microdisplay panel such that each image pixel on the microdisplay is converted into a unique angular direction within the waveguide. In many embodiments, the source of data modulated light is a laser projector comprising a beam scanning mechanism and a light modulator.

In many embodiments, the light control layer is disposed on the lower face of the waveguide—i.e., between the waveguide and the eye box as shown in FIG. 1. The advantage of this arrangement is that scattered light reflected by the light control layer can be extracted through the front surface of the waveguide and hence is not visible from the eyebox. FIG. 2 shows an example of an embodiment in which a light control layer (114) is disposed on the outer face of the waveguide (114). In some embodiments, such as the one shown in FIG. 3, a light control layer (115) can be disposed in proximity to and air separated from an outer surface of the waveguide. In such embodiments, the light control layer can comprise a film applied to a thin substrate (not shown). In some embodiments, upper and lower light control layers (116,117) are disposed on the lower and upper faces of the waveguide (as shown in FIG. 4).

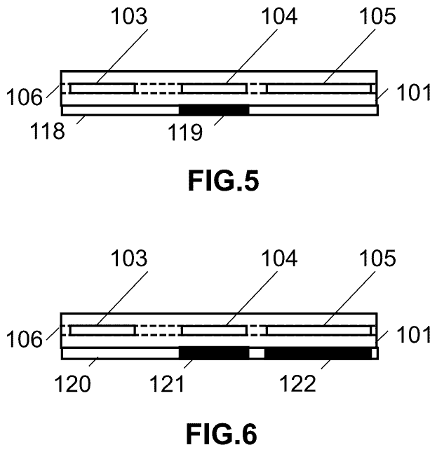

In many embodiments, the light control layer has at least one region having reflection characteristics dependent on at least one property of the light incident on the region. In many embodiments, the property can be selected from spectral bandwidth, incidence angle range, and polarization state. In many embodiments, the light control layer region overlaps a fold grating. For example, FIG. 5 shows a light control layer 118 containing the reflecting region 119 overlapping the fold grating 104. In some embodiments, a light control layer region can overlap an output grating. In some embodiments, the light control layer contains regions overlapping more than one grating. For example, FIG. 6 shows a light control layer 120 containing a reflecting region 121 with a first reflecting characteristic overlapping the fold grating 104 and a reflecting region with a second reflecting characteristic overlapping the output grating 105.

A light control layer according to the principles of embodiments can be configured in many ways. In some embodiments, the light control layer can comprise several layers combined in a stack. In some embodiments, a light control layer can be configured as a narrow band interference filter. In some embodiments, a light control layer can be configured as a dichroic filter. In some embodiments, a light control layer can be provided by a reflection hologram. In some embodiments, a light control layer can be provided by a micro louvre film, which controls reflections by using a louvre structure to control the distribution of light perpendicular to the film. An exemplary micro louvre film is the 3M™ Advanced Light Control Film (ALCF). In some embodiments, a light control layer can be provided by a birefringent film, which can be used to perform various polarization control functions such as but not limited to retardation and/or polarization selection. In some embodiments, a light control layer can be provided by a reflective polarizer. In some embodiments, a light control layer can be provided by a film containing microparticles. In many embodiments, the light control layer can be formed using a coating process such as for example a vacuum coating process in the case of narrow band interference filter. In the case of a light control layer based on a reflection hologram, conventional holographic exposure processes may be used, which can include but are not limited to processes based on ink jet printing disclosed In U.S. patent application Ser. No. 16/203,071 entitled “Systems and Methods for Manufacturing Waveguide Cells,” the disclosure of which is incorporated herein by reference in its entirety. In many embodiments, the light control layer can be applied directly to an outer surface of a waveguide substrate. In some embodiments, a light control layer can be applied to a transparent substrate, which is then mounted in proximity to a waveguide outer surface and separated from the waveguide by a small air gap.

Embodiments may be applied using many types of light source. In some embodiments, a broadband light source can be used. In many embodiments, the light source can be a laser or LED emitters configured for monochromatic illumination in a module comprising emitters of more than one wavelength. In many embodiments, red, green and blue emitters can be used to provide color displays. Laser emitters can allow more precise control of light using narrow band filters.

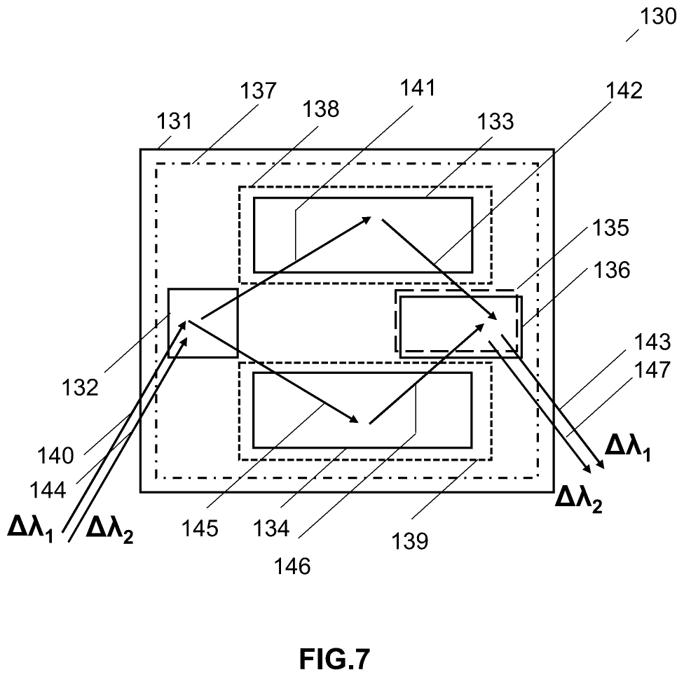

In some embodiments, a display waveguide with bifurcated propagation paths for different spectral bands, for example blue-green and green blue is provided. As shown in the schematic plan view of FIG. 7, the display waveguide 130 comprises a waveguide 131 supporting input grating 132 for coupling light from a source of data modulated light (not shown) into a first propagation path for a first spectral band and a second propagation path for a second spectral band, upper and lower fold gratings 133,134, and an output coupler comprising multiplexed gratings 135,136. The first fold grating 133 can be configured to direct light in a first spectral band Δλ₁ along a first path represented by rays 140-143 from the input coupler to the output coupler grating 135 and to provide a first beam expansion. In many embodiments, the first spectral band corresponds to blue-green and the second spectral band corresponds to green-red. The second fold grating 134 can be configured to direct light in a second spectral band Δλ₂ along a second path represented by the rays 144-147 from the input coupler to the output coupler grating 136 and to provide a first beam expansion. The first and second multiplexed gratings can be configured to direct the first and second spectral bands out of the waveguide with beam expansion orthogonal to the first beam expansion. In the illustrative embodiment, the waveguide 130 includes a light control layer 137 having a first region 138 with high reflectivity in at least one portion of the first spectral band and overlapping the first fold grating 133. The light control layer further includes a second region 139 having high reflectivity in at least one portion of the second spectral band and overlapping the second fold grating 134. In some embodiments, the first spectral band extends from blue to green and the first region has high reflectivity for blue and green light with spectral bandwidths substantially narrower than the first spectral band. In some embodiments, the second spectral band extends from green to red and the second region has high reflectivity for green and red light with spectral bandwidths substantially narrower than the second spectral band. The input coupler can include a prism or a grating. In some embodiments, the first and second fold gratings and the multiplexed grating are formed in a single layer. In some embodiments, the input coupler is a grating formed in the same layer as the fold and output gratings. In some embodiments, the light control layer is formed by a stack of layers each containing a region providing reflection in spectral bandwidth substantially narrower than the first spectral band or the second band. In some embodiments, the source of data modulated light is a laser projector and the light is provided by red, green and blue laser emitters.

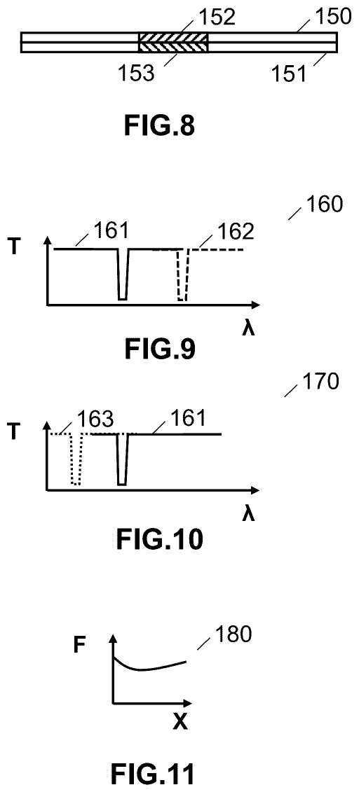

FIG. 8 is a schematic cross section view showing a light control layer configured from two stacked layers 150,151 each supporting narrow band interference filter regions 152,153. In some embodiments, a light control layer in which the regions 152,153 provide narrow band reflectivity in blue and green respectively can be overlaid over the first fold grating 133. Similarly, a light control layer in which the regions 152,153 providing narrow band reflectivity in green and red respectively can be overlaid over the second fold grating 134. FIG. 9 shows the light transmission (T) versus wavelength characteristics 160 resulting from the green (161) and red (162) narrow band filter spectral regions 161. FIG. 10 shows the light transmission (T) versus wavelength characteristics 170 resulting from the blue (163) and green (161) narrow band filter spectral regions 161.

In many embodiments, it can be advantageous to vary the reflection characteristic of a light control layer spatially. FIG. 11 shows a chart 180 illustrating the variation of a reflection characteristic as a function of a spatial coordinate (x). The characteristic F may depend on wavelength band, polarization state, angle of incidence, and other parameters.

### DOCTRINE OF EQUIVALENTS

Although specific fabrication processes are discussed above, many different processes can be implemented in accordance with many different embodiments. It is therefore to be understood that embodiments can be practiced in ways other than specifically described, without departing from the scope and spirit of the present disclosure. Thus, embodiments presented should be considered in all respects as illustrative and not restrictive. Accordingly, the scope of the disclosure should be determined not by the embodiments illustrated, but by the appended claims and their equivalents. Although specific embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

1. A waveguide display comprising:
a substrate transparent to visible light providing at least two total internal reflection surfaces;
a source of an image light comprising a first wavelength and a second wavelength;
an input grating, wherein the input grating couples the image light within the substrate through total internal reflection, wherein the first wavelength is coupled into a first total internal reflection propagation path and the second wavelength is coupled into a second total internal reflection propagation path;
at least one grating configured to provide beam expansion and extraction of the first wavelength in the first total internal reflection propagation path and the second wavelength of the second total internal reflection propagation path into an eyebox; and
at least one light control layer, wherein the at least one light control layer at least partially overlaps the at least one grating, wherein the at least one light control layer is operative to block or divert away scattered light from at least one of the total internal reflection surfaces of the substrate, wherein the scattered light does not follow at least one of the total internal reflection propagation paths from the input grating to the eyebox,
wherein the at least one light control layer comprises a first reflectivity region and a second reflectivity region, wherein the first reflectivity region is operative to reflect the first wavelength and the second reflectivity region is operative to reflect the second wavelength.

2. The waveguide display of claim 1, wherein the at least one light control layer is characterized by a spatially varying reflectivity.

3. The waveguide display of claim 2, wherein the spatially varying reflectivity is based on at least one of wavelength band, polarization state, and angle incidence.

4. The waveguide display of claim 1, wherein the at least one grating is characterized by a rolled k-vector.

5. The waveguide display of claim 1, wherein the at least one grating comprises a first grating and a second grating.

6. The waveguide display of claim 5, wherein the first grating and the second grating are characterized by multiplexed gratings.

7. The waveguide display of claim 5, wherein the first grating and the second grating are in a single layer.

8. The waveguide display of claim 5, wherein the first grating and the second grating are characterized by dual interaction gratings.

9. The waveguide display of claim 5, wherein the first grating and the second grating are characterized by spatially varying pitch.

10. The waveguide display of claim 1, wherein the at least one grating is a Bragg grating.

11. The waveguide display of claim 10, wherein the at least one grating is recorded in at least one of a holographic photopolymer, a holographic polymer dispersed liquid crystal material, and a uniform modulation holographic liquid crystal polymer material.

12. The waveguide display of claim 1, wherein the first wavelength extends from a blue light to a green light and the first reflectivity region has high reflectivity for the blue light and the green light with a wavelength bandwidth substantially narrower than the first wavelength.

13. The waveguide display of claim 1, wherein the second wavelength extends from a green light to a red light and the second reflectivity region has a high reflectivity for the green light and the red light with a wavelength bandwidth substantially narrower than the second wavelength.

14. The waveguide display of claim 1, wherein the input grating and the at least one grating are in a single layer.

15. The waveguide display of claim 1, wherein the at least one light control layer is formed by a stack of layers each containing a region providing reflection in a wavelength bandwidth substantially narrower than the first wavelength and the second wavelength.

16. The waveguide display of claim 1, wherein the source of the image light is a laser projector and the image light is provided by red, green, and blue laser emitters.
